(19) United States
(12) Patent Application Publication
(10) Pub. No.: US 2024/0251428 A1
(43) Pub. Date: Jul. 25, 2024

(54) NR SIDELINK RESOURCE SELECTION BASED ON OVERHEARD RESOURCE RECOMMENDATIONS

(71) Applicant: Nokia Technologies Oy, Espoo (FI)

(72) Inventors: Daniel MEDINA, Munich (DE); Torsten WILDSCHEK, Gloucester (GB)

(21) Appl. No.: 18/558,901

(22) PCT Filed: May 4, 2022
(86) PCT No.: PCT/EP2022/062022

§ 371 Date: Nov. 3, 2023

Related U.S. Application Data
(60) Provisional application No. 63/186,236, filed on May 10, 2021.

(51) Int. Cl. H04W 72/25; H04W 72/563; H04W 92/18

(52) U.S. Cl. CPC H04W 72/25; H04W 72/563; H04W 92/18

(57) ABSTRACT

In accordance with example embodiments of the invention there is at least a method performed by an apparatus including performing determining, by a first user equipment of more than one user equipment of a communication network, a first set of candidate radio resources for sidelink transmission by the first user equipment or a second user equipment of the more than one user equipment; receiving from a third user equipment a second set of preferred radio resources for sidelink transmission by at least one of the second user equipment, the third user equipment, or a fourth user equipment other than the first user equipment of the more than one user equipment; identifying at least one radio resource from the first set of candidate radio resources that overlaps at least partially with a radio resource in the second set of preferred radio resources; determining a subset of the first set of candidate radio resources based at least in part on the identified at least one overlapping radio resource; and at least one of selecting from the determined subset one or more radio resources for sidelink transmission by the first user equipment or transmitting the determined subset to the second user equipment.

### TECHNICAL FIELD

The teachings in accordance with the exemplary embodiments of this invention relate generally to determining resources for sidelink communications and, more specifically, relate to determining resources for sidelink communications based on overheard sidelink resource recommendations for other devices.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

| | |
|---|---|
| CBR | Channel Busy Ratio |
| PSSCH | Physical Sidelink Shared Channel |
| RSRP | Reference Signal Received Power |
| UE | User Equipment |

Wireless devices such as user equipment (UE) may communicate with other UEs over a sidelink. In some cases, a transmitting UE communicates over a sidelink with a receiving UE by communicating sidelink control information (SCI) to determine resources for the transmission and once the resources are reserved, using the resources for wireless communication over a sidelink.

Aspects of example embodiments of the invention as disclosed below relate to such operations as determining resources for wireless sidelink communications, and to identifying best resources for sidelink communications.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows an Inter-UE Coordination Scheme 1;

FIG. 2 shows a resource conflict as a result of near-simultaneous resource (re)selection triggered at two transmitter UEs;

FIG. 3 shows a transmitter UE (Tx_B) that selects a resource overlapping with a resource reserved for transmission by a hidden UE (Tx_D);

FIG. 4 shows how a receiving UE (Rx_A) takes into account an overheard recommendation from a third UE (Rx_C) to a fourth UE (Tx_D) when determining its own recommendation to a transmitting UE (Tx_B);

FIG. 5 shows a sequence diagram for a possible execution of embodiment 1 in accordance with example embodiments of the invention;

FIG. 6 shows how a transmitter UE (Tx_B) takes into account an overheard recommendation from a third UE (Rx_C) to a fourth UE (Tx_D) when selecting resources for its own transmission in accordance with example embodiments of the invention;

FIG. 7 shows a sequence diagram for a possible execution of embodiment 2 in accordance with example embodiments of the invention;

FIG. 8 shows how a transmitter UE (Tx_B) includes in its coordination request to a receiver UE (Rx_A) a recommendation for its own transmission based on an overheard recommendation from a third UE (Rx_C) to a fourth UE (Tx_D) in accordance with example embodiments of the invention;

FIG. 9 shows a sequence diagram for a possible execution of embodiment 3 in accordance with example embodiments of the invention;

FIG. 10 shows a high-level block diagram of various devices used in carrying out various aspects of the invention; and

FIG. 11 shows a method in accordance with example embodiments of the invention which may be performed by an apparatus.

### DETAILED DESCRIPTION

In this invention, there is proposed at least a method and apparatus for determining resources for sidelink communications based on overheard sidelink resource recommendations for other devices.

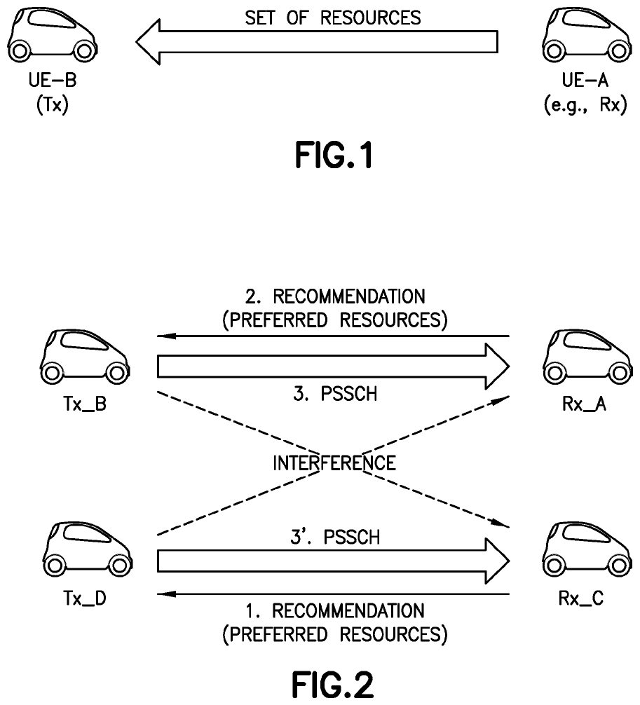

In the RAN1 #104bis-e meeting, progress was made towards the specification of Rel-17 NR sidelink enhancements. In particular, it was agreed that, in Inter-UE Coordination Scheme 1, illustrated in FIG. 1, the coordination information sent from UE-A to UE-B is the set of resources preferred and/or non-preferred for UE-B's transmission.

How UE-A determines the set of resources is currently being considered in RAN1. In particular, a proposal being discussed is that UE-A may use coordination information (e.g., preferred resource set) received from other UEs.

In determining the set of resources preferred or non-preferred for UE-B's transmission, UE-A's sensing results can be used. However, at least a problem exists in that, as illustrated in FIG. 2, it may happen that two (or more) co-located transmitter UEs (Tx_B, Tx_D) trigger their resource (re)selection procedure very close in time, such that the respective sensing results (e.g., at Rx_A, Rx_C) do not yet reflect each other's choices. For example, Rx_C may send a first recommendation (i.e., preferred resource set) to Tx_D for transmission to Rx_C. Shortly afterwards, before any transmission by Tx_D has taken place, Rx_A may send a second recommendation (i.e., preferred resource set) to Tx_B for transmission to Rx_A.

As a result, the content of the first and second recommendations may overlap, potentially resulting in a resource conflict if Tx_B selects a resource overlapping with the resource selected by Tx_D. As illustrated in FIG. 2, this may result in the following interference scenarios:
Transmissions by Tx_B cause interference to the reception of Tx_D's transmissions by Tx_D's intended recipients (e.g., Rx_C); and
Transmissions by Tx_D cause interference to the reception of Tx_B's transmissions by Tx_B's intended recipients (e.g., Rx_A).

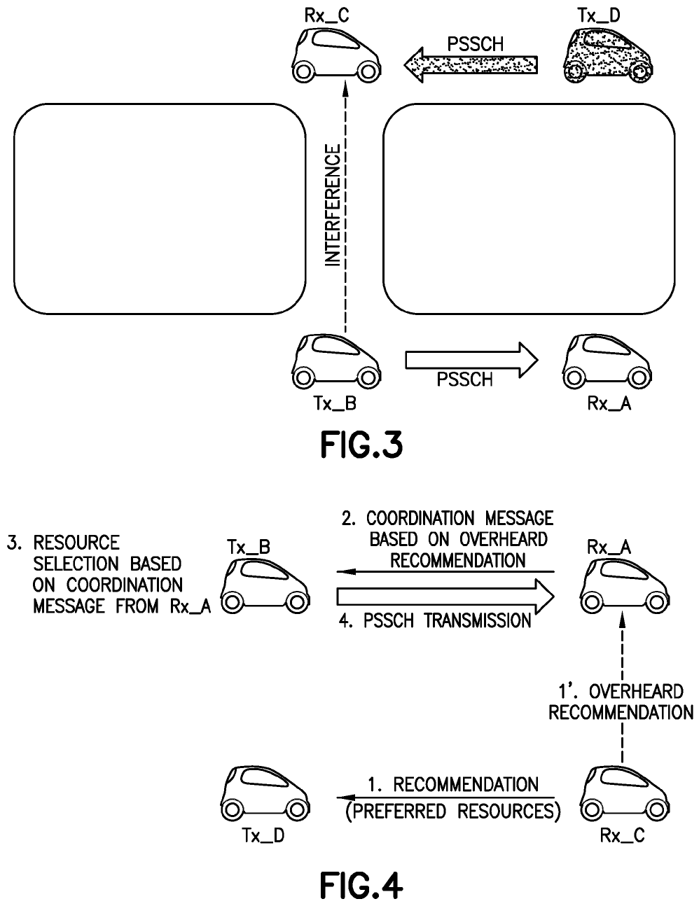

In addition, even if the resource (re)selections are sufficiently far apart in time, in certain situations, as shown in FIG. 3, neither the transmitter UE (Tx_B) nor the receiver UE (Rx_A) may be able to detect transmissions from a hidden UE (Tx_D). Thus, Tx_B may select a resource overlapping with a resource reserved by the hidden UE (Tx_D), potentially causing interference at a corresponding receiver UE (Rx_C).

At the time of this application, a RAN1 discussion point (“UE-A may determine the set of resources preferred and/or non-preferred for UE-B's transmission based on coordination information (e.g., preferred resource set) received from other UEs”) forms one basis for example embodiments of the invention. This discussion point has emerged very recently (RAN1 #104bis-e meeting, April 2021) and, to the best of our knowledge, this has not been discussed or disclosed before.

Example embodiments of the invention work to address at least these issues by performing operations for determining resources for sidelink communications based on overheard sidelink resource recommendations for other devices.

Example embodiments of the invention can include a first UE being configured, when recommending resources for transmission by a second UE (Embodiment 1), selecting resources for its own transmission (Embodiment 2) and/or recommending resources for its own transmission (Embodiment 3), to deprioritize or exclude from its resource selection and/or recommendation a resource that overlaps with a resource indicated in a resource recommendation received from a third UE.

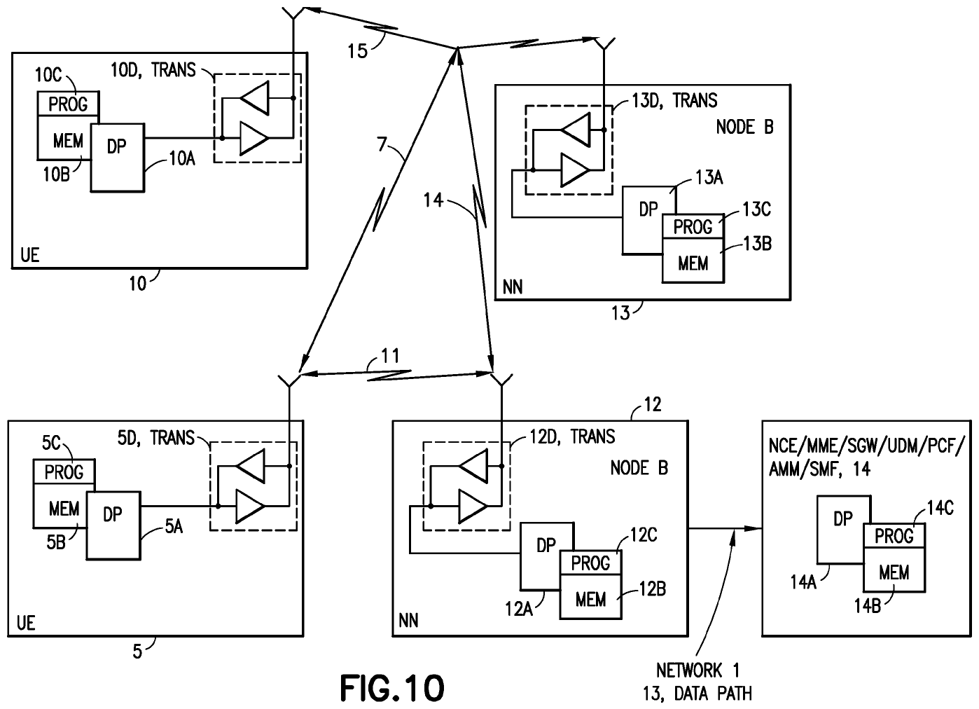

Before describing the example embodiments of the invention in detail, reference is made to FIG. 10 for illustrating a simplified block diagram of various electronic devices of one possible and non-limiting exemplary system that are suitable for use in practicing the example embodiments of this invention.

FIG. 10 shows a block diagram of one possible and non-limiting exemplary system in which the example embodiments of the invention may be practiced. In FIG. 10, a user equipment (UE) 10 and a user equipment (UE) 5 are in wireless communication with a wireless network 1 or network 1 as in FIG. 10. The wireless network 1 or network 1 as in FIG. 10 can comprise a communication network such as a mobile network, e.g., the mobile network 1 or first mobile network as disclosed herein. Any reference herein to a wireless network 1 as in FIG. 10 can be seen as a reference to any wireless network as disclosed herein. Further, the wireless network 1 as in FIG. 10 can also comprise hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a data exchange with the RAN.

The UE 5 (user equipment 5) includes one or more processors DP 5A, one or more memories MEM 5B, and one or more transceivers TRANS 5D interconnected through one or more buses. Each of the one or more transceivers TRANS 5D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 5D can be optionally connected to one or more antennas for communication to NN 12 and NN 13, respectively. The one or more memories MEM 5B include computer program code PROG 5C. The UE 5 communicates with NN 12 and/or NN 13 via a wireless link 11 and/or wireless link 7. The one or more memories MEM 5B and the computer program code PROG 5C are configured to cause, with the one or more processors DP 5A, the UE 5 to perform one or more of the operations as described herein.

The UE 10 (user equipment 10) includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D can be optionally connected to one or more antennas for communication to NN 12 and NN 13, respectively. The one or more memories MEM 10B include computer program code PROG 10C. The UE 10 communicates with NN 12 and/or NN 13 via a wireless link 15 and/or wireless link 14. The one or more memories MEM 10B and the computer program code PROG 10C are configured to cause, with the one or more processors DP 10A, the UE 10 to perform one or more of the operations as described herein.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 10. The NN 12 provides access to wireless devices such as the UE 10 to the wireless network 1. The NN 12 includes one or more processors DP 12A, one or more memories MEM 12C, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 14. Further, the link 11, link 14 and/or any other link may be wired or wireless or both and may implement, e.g., an X2 or Xn interface. Further the link 11 and/or link 14 may be through other network devices such as, but not limited an to NCE/SGW/AMF/UPF device as such the NCE/MME/SGW/UDM/PCF/AMM/SMF 14 of FIG. 10. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 5 and/or UE 10 and/or the wireless network 1. The NN 13 includes one or more processors DP 13A, one or more memories MEM 13B, one or more network interfaces, and one or more transceivers TRANS 12D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or another link. The Link 14 as shown in FIG. 10 can be used for communication between the NN12 and the NN13. These links maybe wired or wireless or both and may implement, e.g., an X2 or Xn interface. Further, as stated above the link 11 and/or link 14 may be through other network devices such as, but not limited to an NCE/MME/SGW device such as the NCE/MME/SGW/UDM/PCF/AMM/SMF 14 of FIG. 10.

The one or more buses of the device of FIG. 10 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D, TRANS 5D, and/or TRANS 10D may be implemented as a remote radio head (RRH), with the other elements of the NN 12 being physically in a different location from the RRH, and the one or more buses 157 could be implemented in part as fiber optic cable to connect the other elements of the NN 12 to a RRH.

It is noted that although FIG. 10 shows a network nodes Such as NN 12 and NN 13. Any of these nodes may can incorporate or be incorporated into an eNodeB or eNB or gNB such as for LTE and NR, and would still be configurable to perform example embodiments of the invention.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMM/SMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management (AMM) functionality, and/or Session Management (SMF) functionality, and/or Authentication Server (AUSF) functionality and which provides connectivity with a further network, such as a telephone network and/or a data communications network (e.g., the Internet), and which is configured to perform any 5G and/or NR operations in addition to or instead of other standards operations at the time of this application. The NCE/MME/SGW/UDM/PCF/AMM/SMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or NN 13, may also be performed at the NCE/MME/SGW/UDM/PCF/AMM/SMF 14.

The NCE/MME/SGW/UDM/PCF/AMM/SMF 14 includes one or more processors DP 14A, one or more memories MEM 14B, and one or more network interfaces (N/W I/F(s)), interconnected through one or more buses coupled with the link 13 and/or 14. In accordance with the example embodiments these network interfaces can include X2 and/or Xn interfaces for use to perform the example embodiments of the invention. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMM/SMF 14 to perform one or more operations which may be needed to support the operations in accordance with the example embodiments of the invention.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, DP5A, and/or DP14A and memories MEM 10B, MEM 12B, MEM 13B, MEM 5B, and/or MEM 14B, and also such virtualized entities create technical effects.

The computer readable memories MEM 12B, MEM 13B, MEM 5B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, MEM 5B, and MEM 14B may be means for performing storage functions. The processors DP10, DP12A, DP13A, DP5A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, DP5A, and DP14A may be means for performing functions, such as controlling the UE 10, UE 5, NN 12, NN 13, and other functions as described herein.

In general, the various embodiments of the user equipment 10 (UE 10) and user equipment 5 (UE 5) can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Example embodiments of the invention can include a first UE being configured, when recommending or selecting resources for transmission by a second UE (Embodiment 1), selecting resources for its own transmission (Embodiment 2) and/or recommending resources for its own transmission (Embodiment 3), to deprioritize or exclude from its resource selection and/or recommendation a resource that overlaps with a resource indicated in a resource recommendation received from a third UE. It is noted that these embodiments are not limiting and example embodiments of the invention can work to adjust these embodiments based on example embodiments of the invention as disclosed herein.

### Embodiment 1: UE-A Determines “(Non-)Preferred Resource Set” for UE-B's Transmission Based on an Overheard Recommendation (“Preferred Resource Set”) from UE-C

In order to minimize the probability of a resource conflict (e.g., due to near-simultaneous resource (re)selection), UE-A may take into account a recently overheard resource recommendation by a third UE (UE-C) when determining its own recommendation for UE-B's transmission, as shown in FIG. 4.

It is likely that one (or more) of the recommended resources in the overheard resource recommendation will be selected for transmission by the respective transmitter UE (e.g., UE-D). Since it may not be possible for UE-A to determine exactly which resource(s) will be selected (or has been selected) for transmission by the respective transmitter (e.g., UE-D), UE-A may deprioritize (in the extreme case, even exclude) from its resource recommendation to UE-B any resource overlapping with a resource indicated in the overheard resource recommendation.

The extent to which an overlapping resource is deprioritized may depend on:
A cardinality of the overheard “preferred resource set”. For example, if the overheard “preferred resource set” is large, the degree of uncertainty as to which of the recommended resources will be selected by UE-D for its own transmission is larger than if the overheard “preferred resource set” is small. In the extreme case that the “preferred resource set” contains a single resource, there is no uncertainty (i.e., UE-D will select the recommended resource), thus UE-A may more aggressively deprioritize (even exclude) any candidate resource overlapping with the recommended resource;
A resource size (e.g., length of contiguously allocated subchannels) of the resources in the overheard recommendation and/or in UE-A's candidate resource set for UE-B's transmission. For example, if the resources in the overheard “preferred resource set” are small (e.g., a single subchannel) and the candidate resources are also small, it may be feasible to even exclude any candidate resources that overlap with resources in the overheard recommendation. However, if the recommended resources and/or the candidate resources are rather large, exclusion may result in very few options left for UE-A to recommend to UE-B, thus UE-A may just slightly deprioritize overlapping resources instead of excluding them;
By how much the resources overlap (e.g., number of overlapping subchannels). For example, if a candidate resource and a resource indicated in the overheard recommendation overlap by a small fraction (e.g., a single subchannel) of their respective sizes, the candidate resource may be deprioritized less strongly than if they overlap by a large fraction of their respective sizes;
An RSRP and/or distance from UE-C. For example, UE-A may deprioritize more aggressively in case UE-C is relatively close to UE-A (i.e., high RSRP);
A CBR measured at UE-A. If the network load is low (i.e., low CBR), UE-A may deprioritize more aggressively (even exclude) any overlapping resources while still having many options left for recommendation to UE-B. On the contrary, when load is high (i.e., high CBR), UE-A may do a softer deprioritization in order to retain some flexibility in its resource recommendation to UE-B; and/or
A transmission priority. If UE-A is able to determine a priority for UE-D's transmission, UE-A may compare the priority of UE-D's transmission with that of UE-B's transmission. If UE-B's priority is higher, UE-A may be less restrictive in its deprioritization. Conversely, if UE-D's priority is higher, UE-A may be more aggressive.

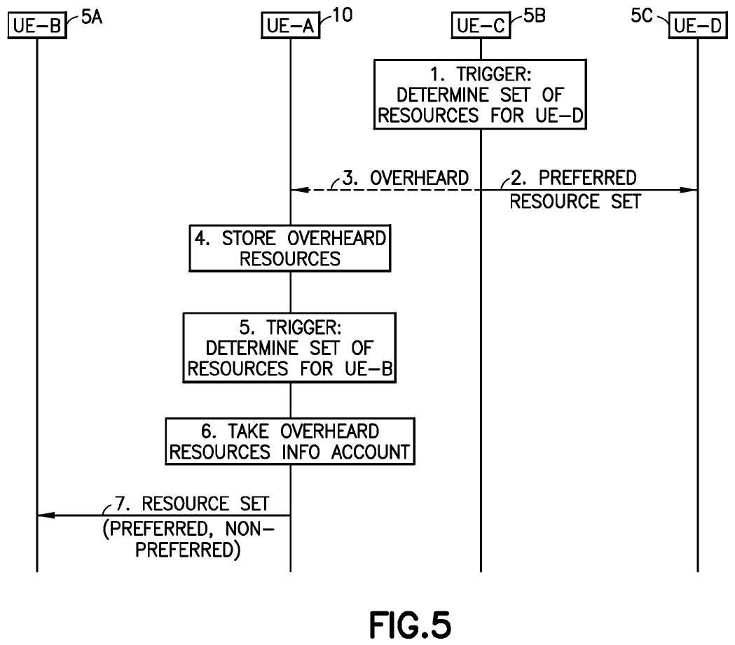

In FIG. 5 there is presented in accordance with example embodiments of the invention a sequence diagram for a possible execution of embodiment 1 as disclosed herein. As shown in FIG. 5 there is communications between a UE-A 10, UE-B 5A, UE-C 5B, and UE-D 5C. Operations of FIG. 5 include:
1. In UE-C 5B, determination of a set of preferred resources for UE-D 5C is triggered;
2 UE-C 5B sends an inter-UE coordination message to UE-D 5C which indicates a set of preferred resources (these are the resources which UE-C 5B recommends that UE-D 5C use for UE-D 5C's transmission(s) to its intended recipients, e.g., UE-C 5B);
3. UE-A 10, while not necessarily an intended recipient of UE-C 5B's inter-UE coordination message, overhears that message and learns about the resources recommended by UE-C 5B to UE-D 5C;
4. UE-A 10 stores that information, so it can be taken into account when/if UE-A 10 needs to determine a set of resources for UE-B 5A;
5. In UE-A 10, determination of a set of resources for UE-B 5A is triggered (this could also have happened at a different point in time, e.g., at the same time as step 1);
6. UE-A 10 determines a set of preferred or non-preferred resources for UE-B 5A and takes its knowledge of UE-C 5B's recommendation to UE-D 5C into account (e.g., by deprioritizing or even excluding resources that UE-D 5C has been recommended to use); and
7. UE-A 10 sends an inter-UE coordination message to UE-B 5A which indicates the set of resources determined in step 6 above.

### Embodiment 2: UE-B Selects Resources for its Own Transmission Based on an Overheard Recommendation (“Preferred Resource Set”) from UE-C

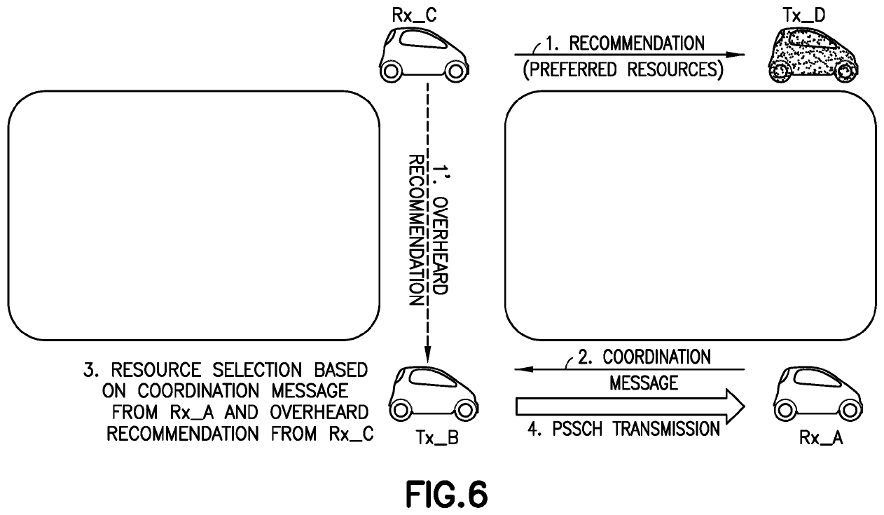

In addition to its own sensing result and coordination information received from UE-A, a transmitter UE (UE-B) may also exploit coordination information received from other UEs (e.g., UE-C). For example, as shown in FIG. 6, if UE-B overhears a resource recommendation (i.e., preferred resource set) sent by UE-C, it may assume that UE-C is an intended recipient of a respective transmission (e.g., from UE-D) and will be receiving in one (or more) of the resources indicated in the overheard resource recommendation. Thus, to avoid interfering with UE-C's reception, UE-B may choose to avoid selecting for its own transmission a resource that overlaps with any resource indicated in the overheard resource recommendation from UE-C.

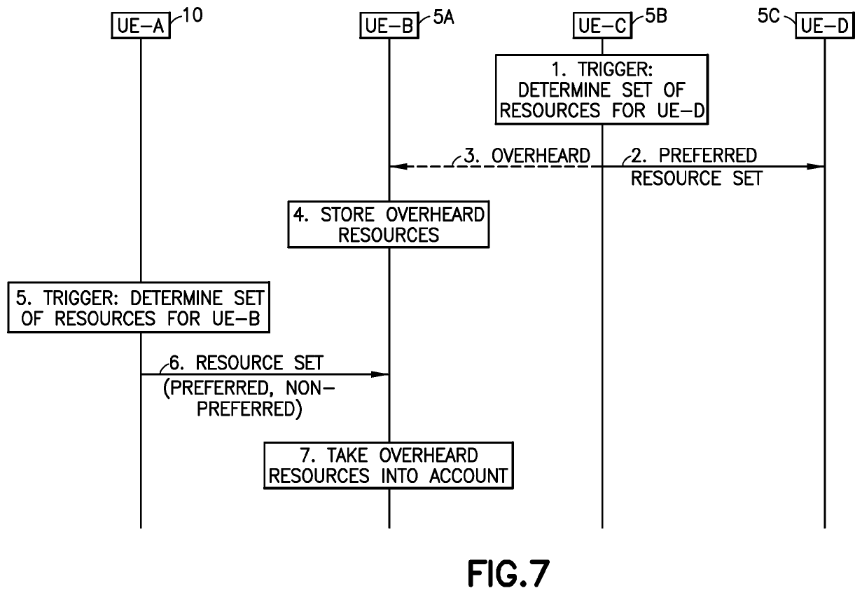

In FIG. 7 there is presented in accordance with example embodiments of the invention a sequence diagram for a possible execution of embodiment 2 as disclosed herein. As shown in FIG. 7 there is communications between a UE-A 10, UE-B 5A, UE-C 5B, and UE-D 5C. Operations of FIG. 7 include:
1. In UE-C 5B, determination of a set of preferred resources for UE-D 5C is triggered;
2. UE-C 5B sends an inter-UE coordination message to UE-D 5C which indicates a set of preferred resources (these are the resources which UE-C 5B recommends that UE-D 5C use for UE-D 5C's transmission(s) to its intended recipients, e.g., UE-C 5B);
3. UE-B 5A, while not necessarily an intended recipient of UE-C 5B's inter-UE coordination message, overhears that message and learns about the resources recommended by UE-C 5B to UE-D 5C;
4. UE-B 5A stores that information, so it can be taken into account when UE-B 5A next needs to perform resource (re)selection for its own transmissions;
5. In UE-A 10, determination of a set of resources for UE-B 5A is triggered. UE-A 10 determines a set of preferred or non-preferred resources for UE-B 5A; UE-A 10 has not overheard UE-C 5B's inter-UE coordination message, e.g., because it is too far from UE-C 5B;
6. UE-A 10 sends an inter-UE coordination message to UE-B 5A which indicates the set of resources determined in step 5 above; and
7. UE-B 5A selects resources for its own transmission(s), taking the overheard resources from steps 3 and 4 above into account in addition to the preferred/non-preferred resources indicated in the inter-UE coordination message sent by UE-A 10 in step 6 above.

### Embodiment 3: UE-B Determines “(Non-)Preferred Resource Set” to be Sent in Coordination Request to UE-A Based on an Overheard Recommendation (“Preferred Resource Set”) from UE-C

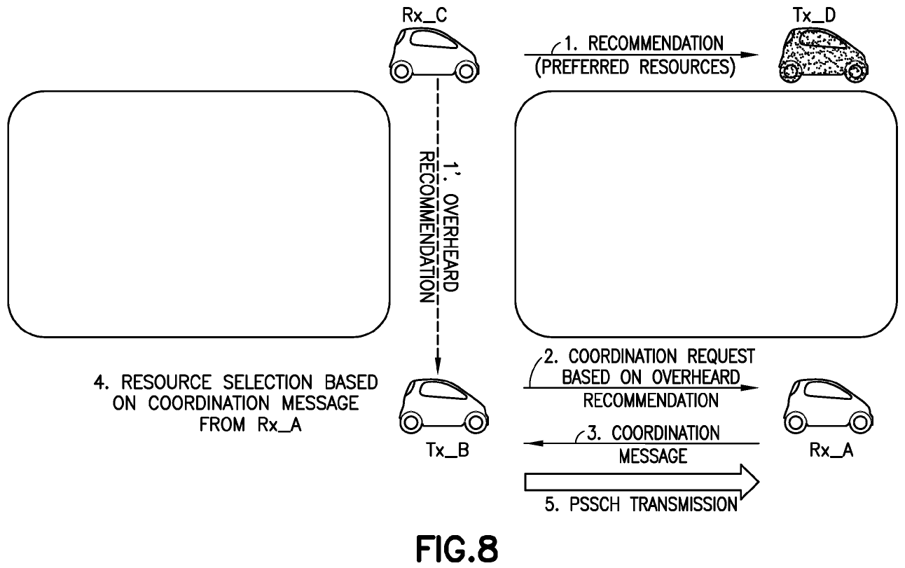

As shown in FIG. 8, in some cases, UE-B may include a resource recommendation (preferred or non-preferred resource set) for its own transmission when transmitting a coordination request to UE-A. Such resource recommendation may itself be based on a resource recommendation overheard by UE-B. For example, if UE-B overhears a resource recommendation (i.e., preferred resource set) sent by UE-C, it may assume that UE-C is an intended recipient of a respective transmission (e.g., from UE-D) and will be receiving in one (or more) of the resources indicated in the overheard resource recommendation. Thus, to avoid interfering with UE-C's reception, UE-B may indicate in its coordination request to UE-A a set of preferred resources that do not overlap with any resource indicated in the overheard resource recommendation. Alternatively, UE-B may indicate in its coordination request to UE-A a set of non-preferred resources including one or more resources that overlap with any resource indicated in the overheard resource recommendation.

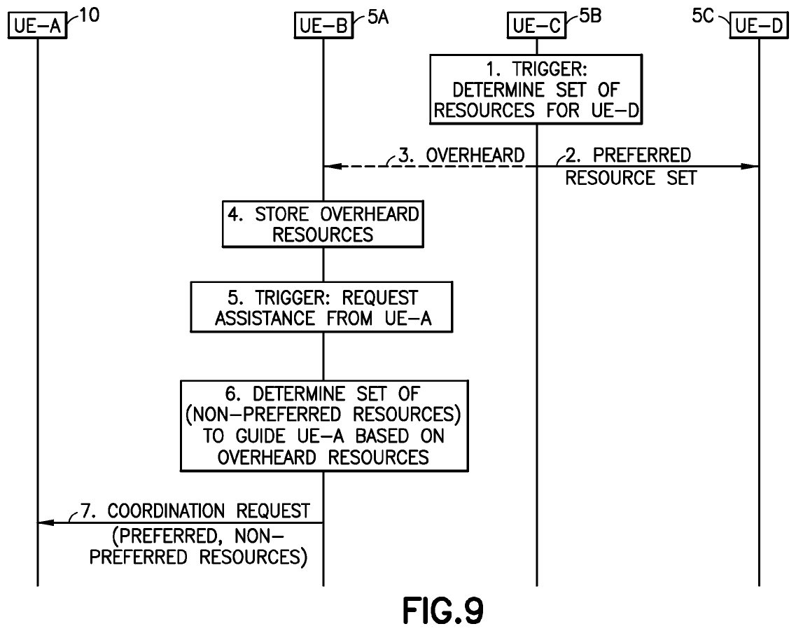

In FIG. 9 there is presented in accordance with example embodiments of the invention a sequence diagram for a possible execution of embodiment 3 as disclosed herein:
1. In UE-C 5B, determination of a set of preferred resources for UE-D 5C is triggered;
2. UE-C 5B sends an inter-UE coordination message to UE-D 5C which indicates a set of preferred resources (these are the resources which UE-C 5B recommends that UE-D 5C use for UE-D 5C's transmission(s) to its intended recipients, e.g., UE-C 5B);
3. UE-B 5A, while not necessarily an intended recipient of UE-C 5B's inter-UE coordination message, overhears that message and learns about the resources recommended by UE-C 5B to UE-D 5C;
4. UE-B 5A stores that information, so it can be taken into account when UE-B 5A next needs to request inter-UE coordination assistance;
5 UE-B 5A determines a need to request inter-UE coordination assistance from UE-A 10;
6. An optional information element to include in the coordination request to UE-A 10 is a set of preferred and/or a set of non-preferred resources, as guidance to UE-A 10. When determining this/these set(s), UE-B 5A takes the overheard resources from steps 3 and 4 into account; and
7. UE-B 5A sends an inter-UE coordination request message to UE-A 10 which indicates the set of resources determined in step 6.

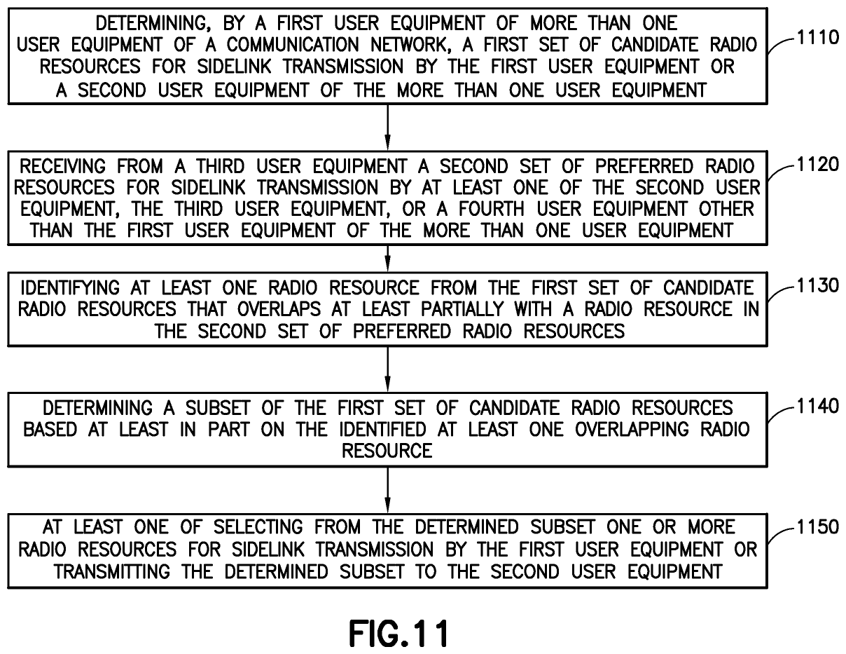

FIG. 11 shows at least one method in accordance with example embodiments of the invention which may be performed by an apparatus. FIG. 11 illustrates operations which may be performed by a device such as, but not limited to, UE 10 as in FIG. 10. As shown in step 1110 of FIG. 11, there is determining, by a first user equipment of more than one user equipment of a communication network, a first set of candidate radio resources for sidelink transmission by the first user equipment or a second user equipment of the more than one user equipment. As shown in step 1120 of FIG. 11, there is receiving from a third user equipment a second set of preferred radio resources for sidelink transmission by at least one of the second user equipment, the third user equipment, or a fourth user equipment other than the first user equipment of the more than one user equipment. As shown in step 1130 of FIG. 11, there is identifying at least one radio resource from the first set of candidate radio resources that overlaps at least partially with a radio resource in the second set of preferred radio resources. As shown in step 1140 of FIG. 11, there is determining a subset of the first set of candidate radio resources based at least in part on the identified at least one overlapping radio resource. Then, as shown in step 1150 of FIG. 11, there is at least one of selecting from the determined subset one or more radio resources for sidelink transmission by the first user equipment or transmitting the determined subset to the second user equipment.

In accordance with the example embodiments as described in the paragraph above, wherein the determined subset is a set of preferred or non-preferred radio resources for sidelink transmission by the first or second user equipment.

In accordance with the example embodiments as described in the paragraphs above, wherein determining the subset of the first set of candidate radio resources based at least in part on the identified at least one overlapping radio resource comprises: deprioritizing or excluding the identified at least one overlapping radio resource from the first set of candidate radio resources.

In accordance with the example embodiments as described in the paragraphs above, wherein the at least one of deprioritizing or excluding the identified at least one overlapping radio resource is based on a cardinality of the second set of preferred radio resources.

In accordance with the example embodiments as described in the paragraphs above, wherein the at least one of deprioritizing or excluding the identified at least one overlapping radio resource is based on a radio resource size of the identified at least one overlapping radio resource and/or a radio resource size of the radio resource in the second set of preferred radio resources.

In accordance with the example embodiments as described in the paragraphs above, wherein the at least one of deprioritizing or excluding the identified at least one overlapping radio resource is based on an extent of overlap between the identified at least one overlapping radio resource and the radio resource in the second set of preferred radio resources.

In accordance with the example embodiments as described in the paragraphs above, wherein the at least one of deprioritizing or excluding the identified at least one overlapping radio resource is based on a channel busy ratio measured at the first user equipment.

In accordance with the example embodiments as described in the paragraphs above, wherein the at least one of deprioritizing or excluding the identified at least one overlapping radio resource is based on a reference signal received power measured at the first user equipment from the third user equipment.

In accordance with the example embodiments as described in the paragraphs above, wherein the at least one of deprioritizing or excluding the identified at least one overlapping radio resource is based on a distance between the first user equipment and the third user equipment.

In accordance with the example embodiments as described in the paragraphs above, wherein the at least one of deprioritizing or excluding the identified at least one overlapping radio resource is based on a priority of the sidelink transmission by the first user equipment or the second user equipment.

A non-transitory computer-readable medium (MEM 10B as in FIG. 10) storing program code (PROG10C as in FIG. 10), the program code executed by at least one processor (DP 10A as in FIG. 10) to perform the operations as at least described in the paragraphs above.

In accordance with an example embodiment of the invention as described above there is an apparatus comprising: means for determining (TRANS 10D, MEM 10B, PROG 10C, and DP 10A as in FIG. 10), by a first user equipment (UE 10 as in FIG. 10) of more than one user equipment of a communication network (Network 1 as in FIG. 10), a first set of candidate radio resources for sidelink transmission by the first user equipment or a second user equipment (UE 5 as in FIG. 10) of the more than one user equipment; receiving (TRANS 10D, MEM 10B, PROG 10C, and DP 10A as in FIG. 10) from a third user equipment (UE 5 as in FIG. 10) a second set of preferred radio resources for sidelink transmission by at least one of the second user equipment, the third user equipment, or a fourth user equipment (UE 5 as in FIG. 10) other than the first user equipment of the more than one user equipment; identifying (TRANS 10D, MEM 10B, PROG 10C, and DP 10A as in FIG. 10) at least one radio resource from the first set of candidate radio resources that overlaps at least partially with a radio resource in the second set of preferred radio resources; determining (TRANS 10D, MEM 10B, PROG 10C, and DP 10A as in FIG. 10) a subset of the first set of candidate radio resources based at least in part on the identified at least one overlapping radio resource; and means for at least one of selecting (TRANS 10D, MEM 10B, PROG 10C, and DP 10A as in FIG. 10) from the determined subset one or more radio resources for sidelink transmission by the first user equipment or transmitting (TRANS 10D, MEM 10B, PROG 10C, and DP 10A as in FIG. 10)) the determined subset to the second user equipment.

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. An apparatus comprising:
at least one processor; and
at least one non-transitory memory including computer program code, where the at least one non-transitory memory and the computer program code are configured, with the at least one processor, to cause the apparatus to at least:
determine, by a first user equipment of more than one user equipment of a communication network, a first set of candidate radio resources for sidelink transmission by the first user equipment or a second user equipment of the more than one user equipment;
receive from a third user equipment a second set of preferred radio resources for sidelink transmission by at least one of the second user equipment, the third user equipment, or a fourth user equipment other than the first user equipment of the more than one user equipment;
identify at least one radio resource from the first set of candidate radio resources that overlaps at least partially with a radio resource in the second set of preferred radio resources;
determine a subset of the first set of candidate radio resources based at least in part on the identified at least one overlapping radio resource; and
at least one of select from the determined subset one or more radio resources for sidelink transmission by the first user equipment or transmit the determined subset to the second user equipment.

2. The apparatus of claim 1, wherein the determined subset is a set of preferred or non-preferred radio resources for sidelink transmission by the first or second user equipment.

3. The apparatus of claim 1, wherein determining the subset of the first set of candidate radio resources based at least in part on the identified at least one overlapping radio resource comprises:
deprioritizing or excluding the identified at least one overlapping radio resource from the first set of candidate radio resources.

4. The apparatus of claim 3, wherein the at least one of deprioritizing or excluding the identified at least one overlapping radio resource is based on a cardinality of the second set of preferred radio resources.

5. The apparatus of claim 3, wherein the at least one of deprioritizing or excluding the identified at least one overlapping radio resource is based on a radio resource size of the identified at least one overlapping radio resource and/or a radio resource size of the radio resource in the second set of preferred radio resources.

6. The apparatus of claim 3, wherein the at least one of deprioritizing or excluding the identified at least one overlapping radio resource is based on an extent of overlap between the identified at least one overlapping radio resource and the radio resource in the second set of preferred radio resources.

7. The apparatus of claim 3, wherein the at least one of deprioritizing or excluding the identified at least one overlapping radio resource is based on a channel busy ratio measured at the first user equipment.

8. The apparatus of claim 3, wherein the at least one of deprioritizing or excluding the identified at least one overlapping radio resource is based on a reference signal received power measured at the first user equipment from the third user equipment.

9. The apparatus of claim 3, wherein the at least one of deprioritizing or excluding the identified at least one overlapping radio resource is based on a distance between the first user equipment and the third user equipment.

10. The apparatus of claim 3, wherein the at least one of deprioritizing or excluding the identified at least one overlapping radio resource is based on a priority of the sidelink transmission by the first user equipment or the second user equipment.

11. A method, comprising:
determining, by a first user equipment of more than one user equipment of a communication network, a first set of candidate radio resources for sidelink transmission by the first user equipment or a second user equipment of the more than one user equipment;
receiving from a third user equipment a second set of preferred radio resources for sidelink transmission by at least one of the second user equipment, the third user equipment, or a fourth user equipment other than the first user equipment of the more than one user equipment;
identifying at least one radio resource from the first set of candidate radio resources that overlaps at least partially with a radio resource in the second set of preferred radio resources;
determining a subset of the first set of candidate radio resources based at least in part on the identified at least one overlapping radio resource; and
at least one of selecting from the determined subset one or more radio resources for sidelink transmission by the first user equipment or transmitting the determined subset to the second user equipment.

12. The method of claim 11, wherein the determined subset is a set of preferred or non-preferred radio resources for sidelink transmission by the first or second user equipment.

13. The method of claim 11, wherein determining the subset of the first set of candidate radio resources based at least in part on the identified at least one overlapping radio resource comprises:
deprioritizing or excluding the identified at least one overlapping radio resource from the first set of candidate radio resources.

14. The method of claim 13, wherein the at least one of deprioritizing or excluding the identified at least one overlapping radio resource is based on a cardinality of the second set of preferred radio resources.

15. The method of claim 13, wherein the at least one of deprioritizing or excluding the identified at least one overlapping radio resource is based on a radio resource size of the identified at least one overlapping radio resource and/or a radio resource size of the radio resource in the second set of preferred radio resources.

16. The method of claim 13, wherein the at least one of deprioritizing or excluding the identified at least one overlapping radio resource is based on an extent of overlap between the identified at least one overlapping radio resource and the radio resource in the second set of preferred radio resources.

17. The method of claim 13, wherein the at least one of deprioritizing or excluding the identified at least one overlapping radio resource is based on a channel busy ratio measured at the first user equipment.

18. The method of claim 13, wherein the at least one of deprioritizing or excluding the identified at least one overlapping radio resource is based on a reference signal received power measured at the first user equipment from the third user equipment.

19. The method of claim 13, wherein the at least one of deprioritizing or excluding the identified at least one overlapping radio resource is based on a distance between the first user equipment and the third user equipment.

20. The method of claim 13, wherein the at least one of deprioritizing or excluding the identified at least one overlapping radio resource is based on a priority of the sidelink transmission by the first user equipment or the second user equipment.
